(19) United States
(12) Patent Application Publication
(10) Pub. No.: US 2016/0225077 A1
(43) Pub. Date: Aug. 4, 2016

(54) SYSTEMS AND METHODS FOR RETRIEVING AND PROCESSING CREDIT DATA FOR CENTRALIZED REVIEW

(71) Applicant: TRANS UNION LLC, CHICAGO, IL (US)

(72) Inventors: KEITH TILLMAN, ROSWELL, GA (US); F.J. GUARRERA, MONKTON, MD (US); CARRIE HENNY, DOWNERS GROVE, IL (US); TIM E. AKE, WOODSTOCK, GA (US); CRAIG LACHAPPELLE, BETHESDA, MD (US); MIKE FULMER, AVONDALE ESTATES, GA (US); ANTHONY OKRUTNY, MCDONOUGH, GA (US); MARY ANN BLOTZER, ATLANTA, GA (US)

(21) Appl. No.: 15/009,497

(22) Filed: Jan. 28, 2016

Related U.S. Application Data
(60) Provisional application No. 62/108,950, filed on Jan. 28, 2015.

(51) Int. Cl. G06Q 40/02

(52) U.S. Cl. CPC G06Q 40/025

(57) ABSTRACT

Systems and methods are provided for retrieving, processing, and formatting credit data from multiple credit bureaus. Credit data review requests can be received from a financial institution for retrieving credit data for individuals. The credit data may be retrieved from the credit bureaus based on the request. Data fields in the credit data can be identified and formatted for comparison purposes. The formatted data fields may be transmitted to a terminal for review by a user. Financial institutions can utilize the systems and methods to ease compliance and auditing processes when verifying modifications to credit data for individuals at the credit bureaus and retrieving credit data to verify disputed information.

### CROSS-REFERENCE TO RELATED APPLICATION

This application claims the benefit of U.S. Provisional Patent Application No. 62/108,950, filed Jan. 28, 2015, the contents of which are fully incorporated herein by reference.

### TECHNICAL FIELD

This invention relates to systems and methods for retrieving and processing credit data for centralized review. More particularly, the invention provides systems and methods for retrieving credit data from multiple credit bureaus based on a request, and formatting the retrieved credit data for display to a terminal for ease of comparison.

### BACKGROUND OF THE INVENTION

The consumer lending industry bases its decisions to grant credit or make loans, or to give consumers preferred credit or loan terms, on the general principle of risk, i.e., risk of delinquency. Credit and lending institutions typically avoid granting credit or loans to high risk consumers, or may grant credit or lending to such consumers at higher interest rates or other terms less favorable than those typically granted to consumers with low risk. Consumer credit data, including consumer credit information, is collected and used by credit bureaus, financial institutions, and other entities for assessing creditworthiness and aspects of a consumer's financial and credit history.

Consumer credit data typically includes information such as indicative data to identify the consumer, and financial data related to trade lines, e.g., lines of credit, such as the status of debt repayment, on-time payment records, etc. The financial data is often received from financial institutions, such as banks, credit unions, and savings and loan institutions; credit card issuers; and similar entities that grant credit or loans, for example. The historical aspects of the financial data are often utilized by entities to determine whether to grant credit or loans to a consumer.

In the course of business, financial institutions may take various actions that can cause modifications to the credit data of their customers that are stored at one or more credit bureaus. Such modifications may include, for example, changes to trade lines as a result of a dispute resolution process, changing the balance on a trade line, and removing the trade line from the credit data of a consumer because it is not their trade line. As part of their compliance and auditing processes, the financial institutions subsequently verify that the modifications have been accurately reported by the credit bureaus, in accordance with applicable laws and regulations. For example, the financial institutions may ensure that a dispute was properly characterized in the credit data at the credit bureaus. In other situations, consumers may file disputes with financial institutions regarding information in their credit data. The financial institutions may retrieve the credit data of such consumers from the credit bureaus to verify the disputed information.

To retrieve the credit data (after it is modified or to verify disputed information), the financial institutions currently access each credit bureau through separate systems and retrieve the credit data for the customers at issue. The retrieved credit data often includes information for other trade lines, accounts, etc. that are not being verified. As such, the retrieved credit data must be reviewed to find the relevant information that is to be verified. Once the relevant information is found in the credit data from a particular credit bureau, it must be compared to the corresponding information in the credit data from the other credit bureaus. This process may be laborious, time-consuming, and susceptible to errors.

Therefore, there exists an opportunity for systems and methods that can retrieve credit data from multiple credit bureaus, identify relevant data fields in the retrieved credit data from each credit bureau, and format the data fields for comparison, in order to, among other things, ease the compliance and auditing processes for financial institutions.

### SUMMARY OF THE INVENTION

The invention is intended to solve the above-noted problems by providing systems and methods for retrieving, processing, and formatting credit data from multiple credit bureaus. The systems and methods are designed to, among other things: (1) receive a credit data review request; (2) retrieve credit data from the credit bureaus based on the request; (3) identify data fields in the credit data; and (4) format the data fields for comparison.

### BRIEF DESCRIPTION OF THE DRAWINGS

FIG. 1 is a block diagram illustrating a system for retrieving, processing, and formatting credit data from multiple credit bureaus.

FIG. 2 is a flowchart illustrating operations for retrieving, processing, and formatting credit data from multiple credit bureaus using the system of FIG. 1.

FIG. 3 is an exemplary screenshot of an input form for entering a credit data review request, as displayed using the system of FIG. 1.

FIG. 4 is an exemplary screenshot of a response page after processing of a credit data review request, as displayed using the system of FIG. 1.

FIGS. 5-7 are exemplary screenshots of credit data retrieved from credit bureaus, as displayed using the system of FIG. 1.

FIG. 8 is an exemplary screenshot of an input form for searching for previously retrieved credit data, as displayed using the system of FIG. 1.

FIG. 9 is an exemplary screenshot of previously retrieved credit data records, as displayed using the system of FIG. 1.

FIG. 10 is an exemplary screenshot of a single previously retrieved credit data record, as displayed using the system of FIG. 1.

FIG. 11 is an exemplary screenshot of formatted data fields of credit data, as displayed using the system of FIG. 1.

FIG. 12 is an exemplary screenshot of multiple trade lines in the retrieved credit data for selection by a user, as displayed using the system of FIG. 1.

FIG. 13 is an exemplary screenshot of multiple trade lines in the retrieved credit data as selected by a user, as displayed using the system of FIG. 1

FIG. 14 is an exemplary screenshot of selected trade lines of interest, as displayed using the system of FIG. 1.

FIG. 15 is an exemplary screenshot of the historical payment pattern for selected trade lines of interest, as displayed using the system of FIG. 1.

### DETAILED DESCRIPTION OF THE INVENTION

The description that follows describes, illustrates and exemplifies one or more particular embodiments of the invention in accordance with its principles. This description is not provided to limit the invention to the embodiments described herein, but rather to explain and teach the principles of the invention in such a way to enable one of ordinary skill in the art to understand these principles and, with that understanding, be able to apply them to practice not only the embodiments described herein, but also other embodiments that may come to mind in accordance with these principles. The scope of the invention is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers, such as, for example, in cases where such labeling facilitates amore clear description. Additionally, the drawings set forth herein are not necessarily drawn to scale, and in some instances proportions may have been exaggerated to more clearly depict certain features. Such labeling and drawing practices do not necessarily implicate an underlying substantive purpose. As stated above, the specification is intended to be taken as a whole and interpreted in accordance with the principles of the invention as taught herein and understood to one of ordinary skill in the art.

With respect to the exemplary systems, components and architecture described and illustrated herein, it should also be understood that the embodiments may be embodied by, or employed in, numerous configurations and components, including one or more systems, hardware, software, or firmware configurations or components, or any combination thereof as understood by one of ordinary skill in the art. Accordingly, while the drawings illustrate exemplary systems including components for one or more of the embodiments contemplated herein, it should be understood that with respect to each embodiment, one or more components may not be present or necessary in the system.

It should also be noted that the disclosures made in this specification are in accordance with the principles of the embodiments(s), which are intended to be disclosed or interpreted to their broadest extent under the patent laws, and while such disclosure may describe or otherwise cover subject matter that may be regulated by other existing laws or regulations, including, without limitation, the Fair Credit Reporting Act (FCRA) or the Equal Credit Opportunity Act (ECOA), nothing in this disclosure is intended to suggest or imply noncompliance with any such law or regulation by the assignee.

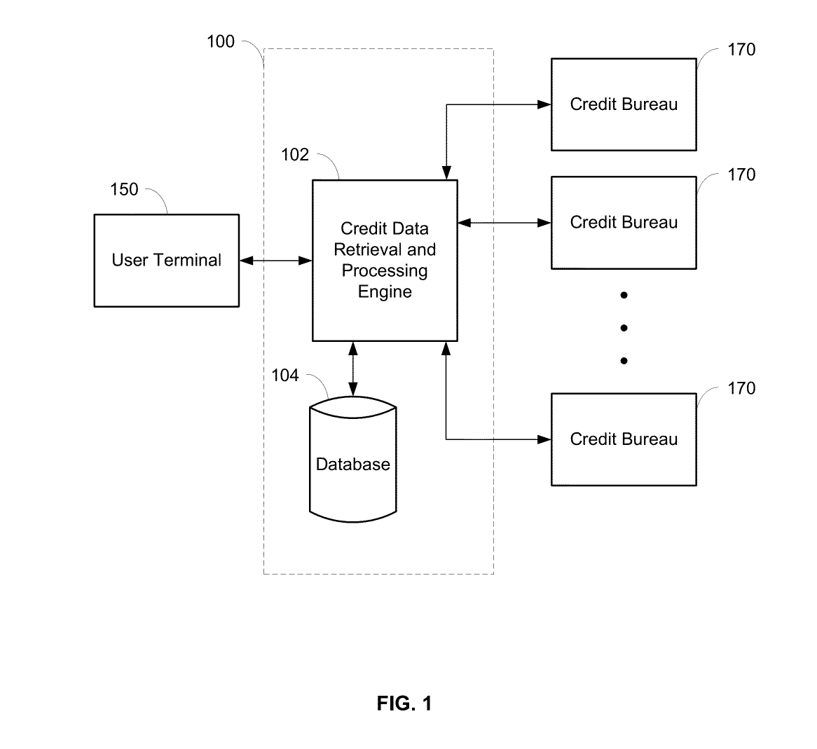

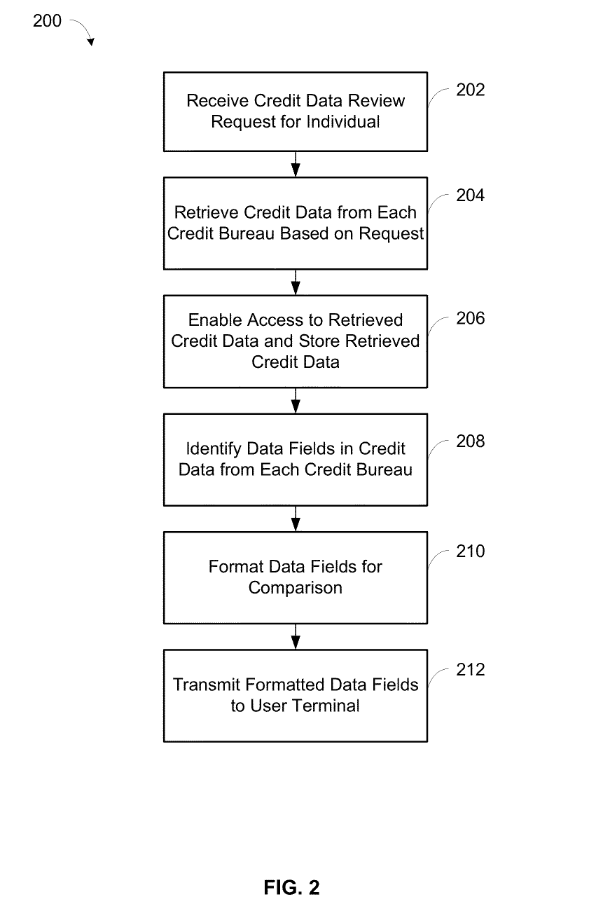

FIG. 1 illustrates a centralized credit data review system 100 for retrieving, processing, and formatting credit data from multiple credit bureaus 170, in accordance with one or more principles of the invention. A process 200 for the retrieval, processing, and formatting of such credit data that may utilize the system 100 is shown in FIG. 2. The system 100 and the process 200 may receive a credit data review request for an individual from a user terminal 150; retrieve credit data for the individual from multiple credit bureaus 170, based on the request; identify data fields in the retrieved credit data; format the data fields for comparison; and transmit the formatted data fields to the user terminal 150 for display. Accordingly, personnel of financial institutions operating the user terminal 150 can more easily request, view, and compare credit data of their customers in a streamlined and centralized manner in order to assist with their compliance and auditing processes. The credit data at the credit bureaus 170 may include information associated with individuals that is related to, for example, credit header data (e.g., name, date of birth, etc.), inquiries, balance changes, trade lines, balances, activations, delinquencies, and payments. Various components of the system 100 may be implemented using software executable by one or more servers or computers, such as a computing device with a processor and memory.

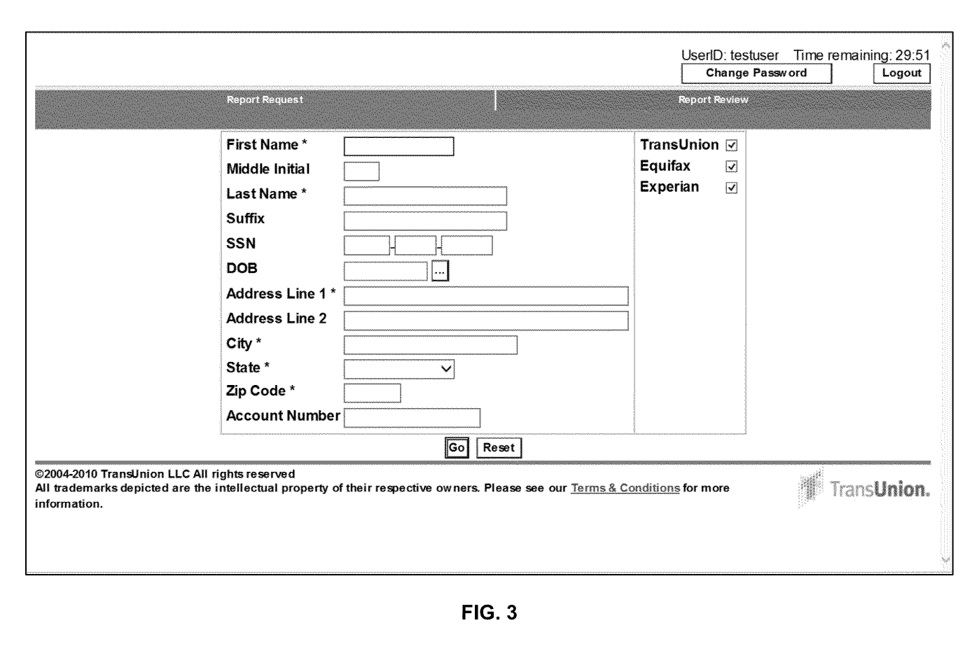

In an embodiment, a credit data retrieval and processing engine 102 in the system 100 may receive a credit data review request for an individual, such as at step 202 of the process 200. For example, the request may originate from a financial institution that desires to retrieve credit data for one of their customers to verify that particular credit data was correctly updated at the credit bureaus 170 after the completion of a dispute resolution process. As another example, a financial institution may initiate a request to retrieve credit data for one of their customers to retrieve credit data that the customer has disputed. The credit data review request may include identifying information for the individual whose credit data is being requested (e.g., name, address, social security number, etc.), account numbers related to the desired credit data, account types related to the desired credit data, desired data fields in the desired credit data, one or more particular credit bureaus 170 to retrieve the credit data from, and/or other information for retrieving credit data for the individual. The credit data review request may be received through a webpage hosted by the credit data retrieval and processing engine 102, in some embodiments. In other embodiments, the financial institution may be required to securely log into the credit data retrieval and processing e 102 in order to make credit data review requests and view credit data. FIG. 3 shows an exemplary screenshot of an input form that allows a user to enter a credit data review request.

The credit data for the individual may be retrieved by the credit data retrieval and processing engine 102 from the credit bureaus 170, based on the credit data review request, such as at step 204. The credit data may be retrieved by the credit data retrieval and processing engine 102 for the desired individual by querying the credit bureaus 170 with appropriate requests, and then receiving the credit data at the credit data retrieval and processing engine 102 from the credit bureaus 170. The credit bureaus 170 may include, for example, TransUnion, Experian, Equifax, and/or Innovis, and the credit data may be stored at the credit bureaus 170 in one or more databases (not shown).

In some embodiments, the credit data review request may have specified particular credit bureaus 170 to retrieve data from. In this case, the credit data retrieval and processing engine 102 may retrieve credit data from only those specified credit bureaus 170. In other embodiments, the credit data review request may have specified particular accounts and/or account types to retrieve from the credit data of the individual. In this case, the credit data retrieval and processing engine 102 may retrieve this particular credit data from the credit bureaus 170, For example, the financial institution may have specified in the credit data review request to only retrieve credit data for an individual's car loans. In this way, other non-relevant credit data (e.g., mortgages, credit cards, etc.) would not be retrieved from the credit bureaus 170. The retrieved credit data may be in any suitable format, such as Extensible Markup Language (XML) or other format.

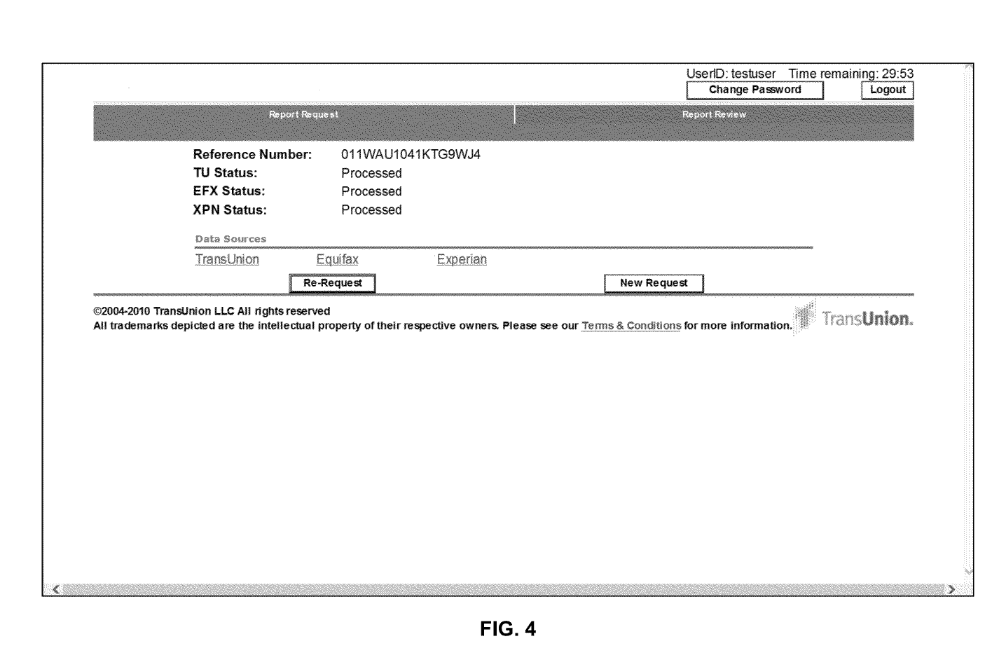

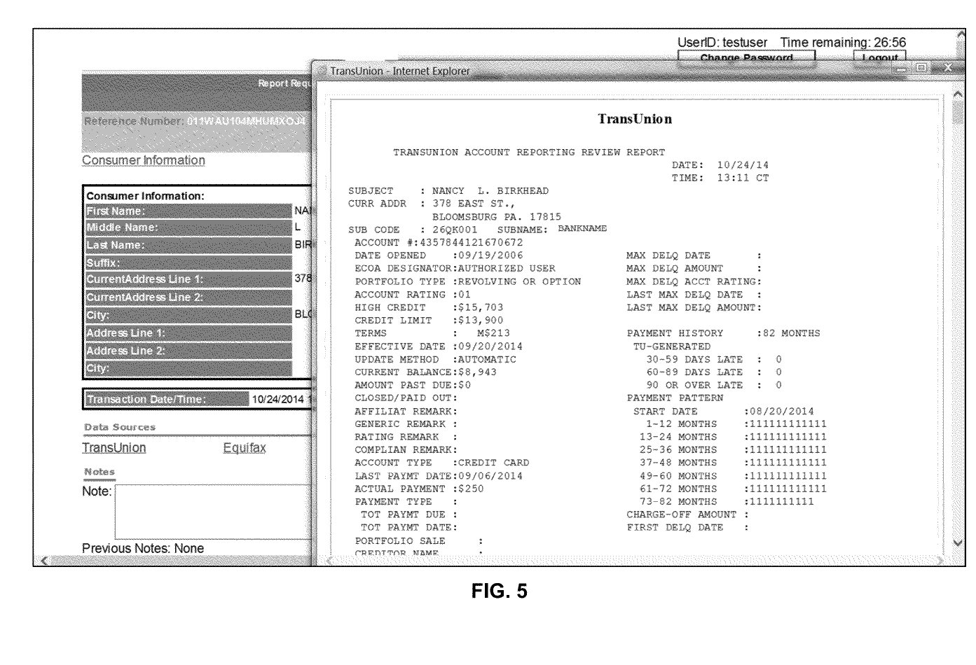

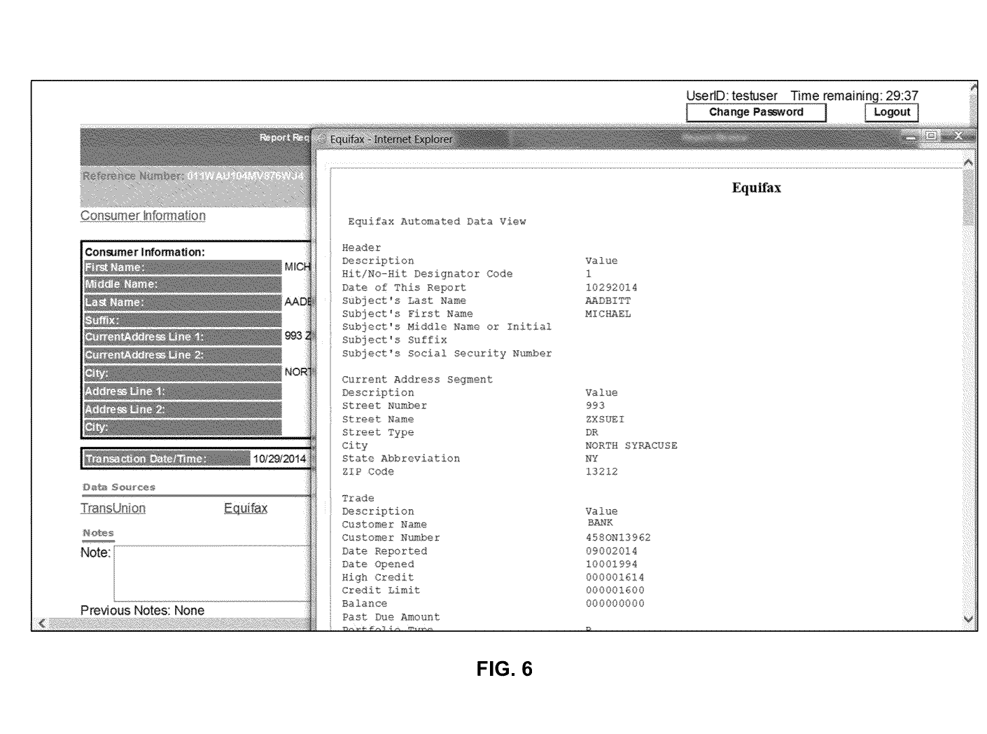

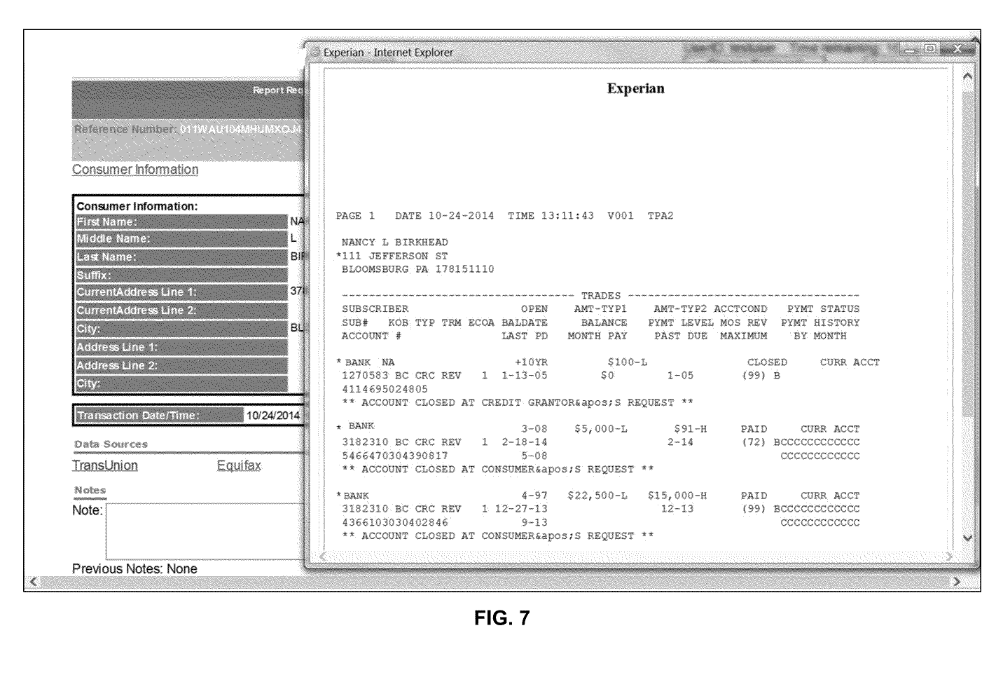

Access to the retrieved credit data may be made available to the user at step 206. The credit data retrieved from each of the credit bureaus 170, for example, may be accessed by a user via a page shown in response to processing of the credit data review request, such as shown in the exemplary screenshot of FIG. 4. As shown in FIG. 4, a user may view a reference number assigned to the credit data review request, view the status of the credit data retrieval for each of the credit bureaus 170, and access links to the raw credit data retrieved from each of the credit bureaus 170, FIGS. 5-7 show exemplary screenshots of the credit data retrieved from the various credit bureaus 170 that may be viewed and/or printed by the user when the user accesses the links.

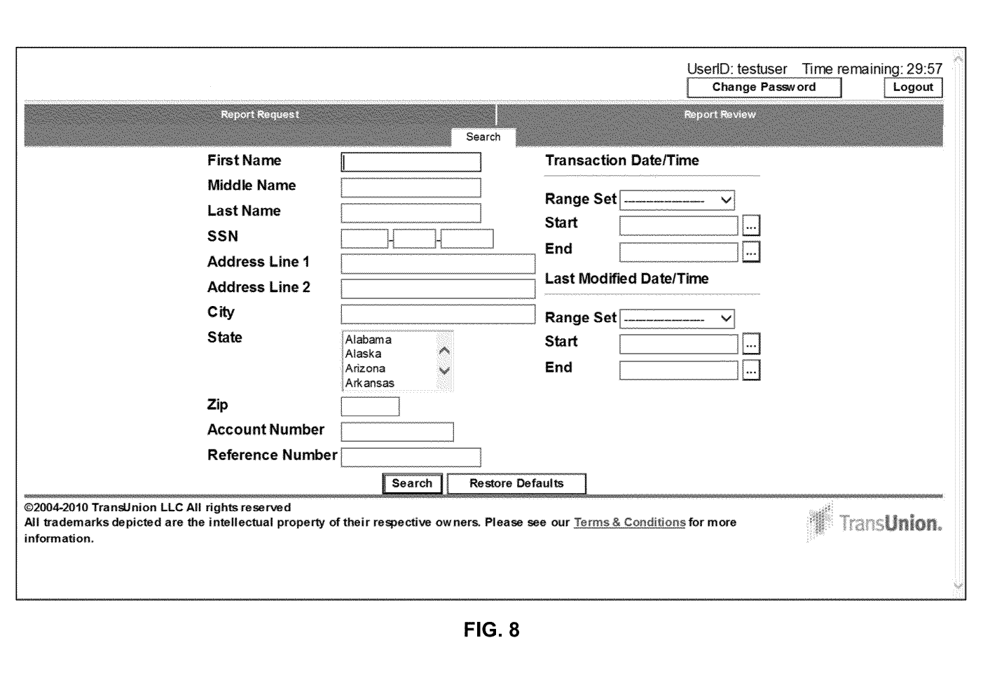

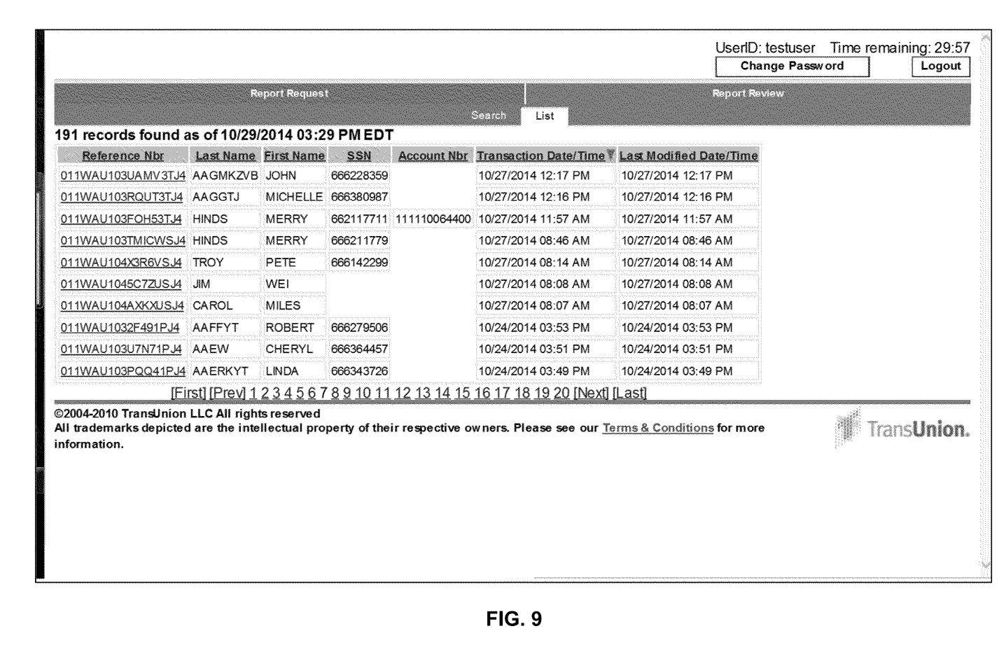

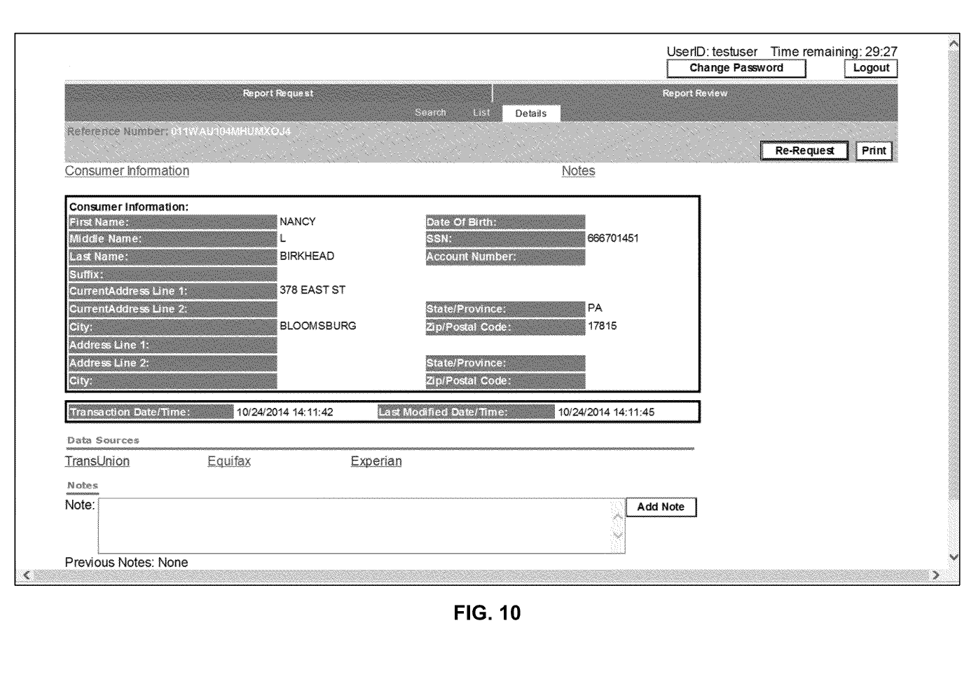

The retrieved credit data may also be stored at step 206 by the credit data retrieval and processing engine 102 in a database 104. The credit data may be stored temporarily in the database 104 to facilitate processing of the data, as detailed below. In some embodiments, the credit data may be stored in the database 104 so that a user can request the review of credit data that had been previously retrieved by the credit data retrieval and processing engine 102 from the credit bureaus 170. In this situation, the credit data retrieval and processing engine 102 can check the database 104 for the existence of the requested credit data prior to querying the credit bureaus 170 for the credit data. An exemplary screenshot of an input form that allows a user to search for previously retrieved credit data is shown in FIG. 8. Previously retrieved credit data may be displayed so that a user can find particular records, such as shown in FIG. 9. The display of previously retrieved credit data may be sorted by the user based on identifying information (name, social security number, account number, etc.) and transaction date and time, for example. Once a particular record is selected by the user, further details of the previously retrieved credit data may be displayed, such as shown in FIG. 10, including links to the raw credit data retrieved from each of the credit bureaus 170 and notes that may have been previously entered.

Data fields in the retrieved credit data can be identified by the credit data retrieval and processing engine 102, such as at step 208. Particular data fields may have been specified for review by a user in the credit data review request received at step 202, for example. Data fields may include some or all of the data fields supplied from the credit bureaus 170, for example, remarks, special comments, name, address, social security number, other indicative data, financial data, and/or other information in the credit data. To identify the data fields, the credit data retrieval and processing engine 102 may analyze the credit data from each credit bureau and search for titles, headers, and/or other information that identify the data fields. In some embodiments, the retrieved credit data may be in a defined format specified by the credit bureaus 170 so that the credit data retrieval and processing engine 102 can identify the data fields. For example, the defined format may specify that the account number, financial institution, credit limit, and other information are in particular positions in a line of text. In other embodiments, the credit data retrieval and processing engine 102 may utilize regular expressions and/or other techniques for identifying the data fields. In further embodiments, the credit data retrieval and processing engine 102 may perform transformation operations, e.g., expanding abbreviations, converting dates, etc., on the data fields and/or the credit data to ease comparison of the information from different credit bureaus 170, In some embodiments, the credit data retrieval and processing engine 102 may not modify the raw credit data as retrieved from credit bureaus 170.

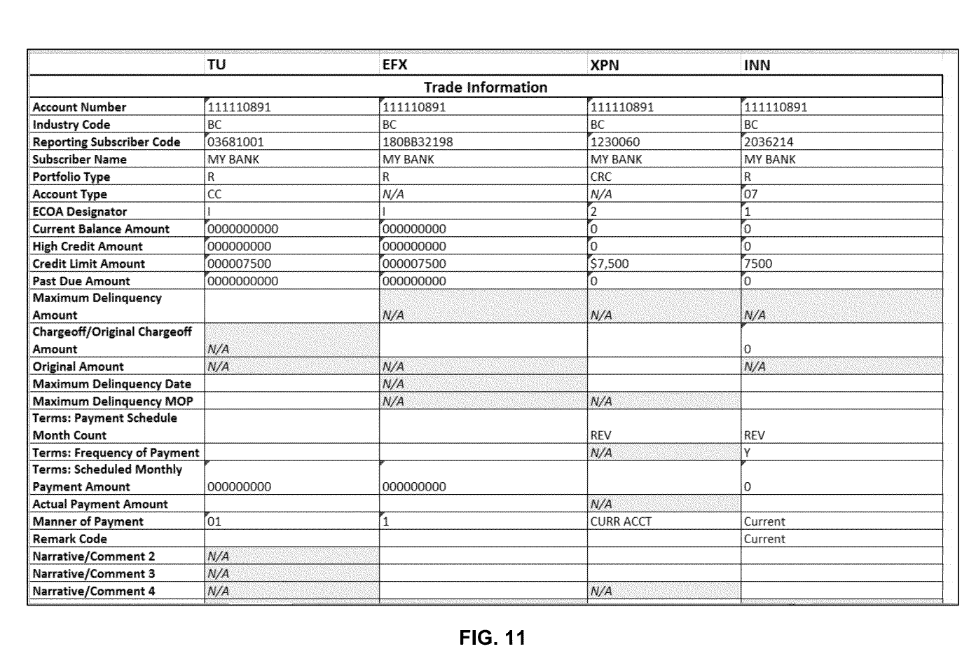

The credit data retrieval and processing engine 102 may format the data fields identified at step 208 for comparison, such as at step 210. The data fields from each credit bureau may be formatted so that they can be easily compared by a user, such as by placing the data fields from each credit bureau next to one another. For example, if the name of an individual was modified, the name data fields from each credit bureau can be displayed next to one another for quick comparison by a user. The formatted data fields can be transmitted from the credit data retrieval and processing engine 102 to the user terminal 150 for display to the user, such as at step 212. The formatted data fields may be transmitted in a text format, HTML format, XML format, and/or other appropriate format, for example. In some embodiments, the formatted data fields can be displayed in a web browser application on the user terminal 150. The display on the user terminal 150 may also include, for example, meanings of abbreviations, terminology definitions, etc. An exemplary screenshot of formatted data fields is shown in FIG. 11. As shown in FIG. 11, data fields from each credit bureau (e.g., TransUnion (TU), Equifax (EFX), Experian (XPN), and Innovis (INN)) are displayed next to one another so that a user can quickly and easily compare the credit data for a particular trade line.

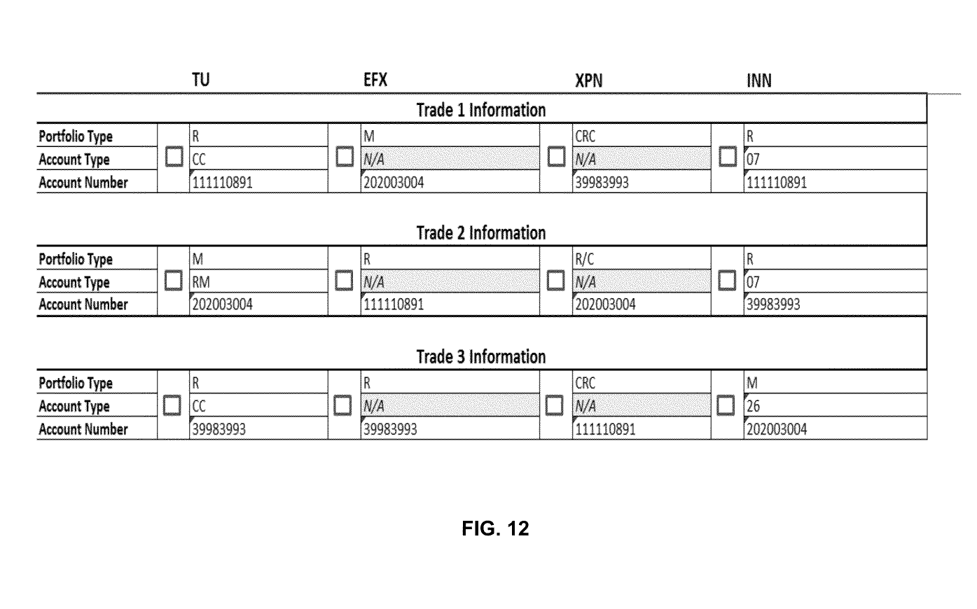

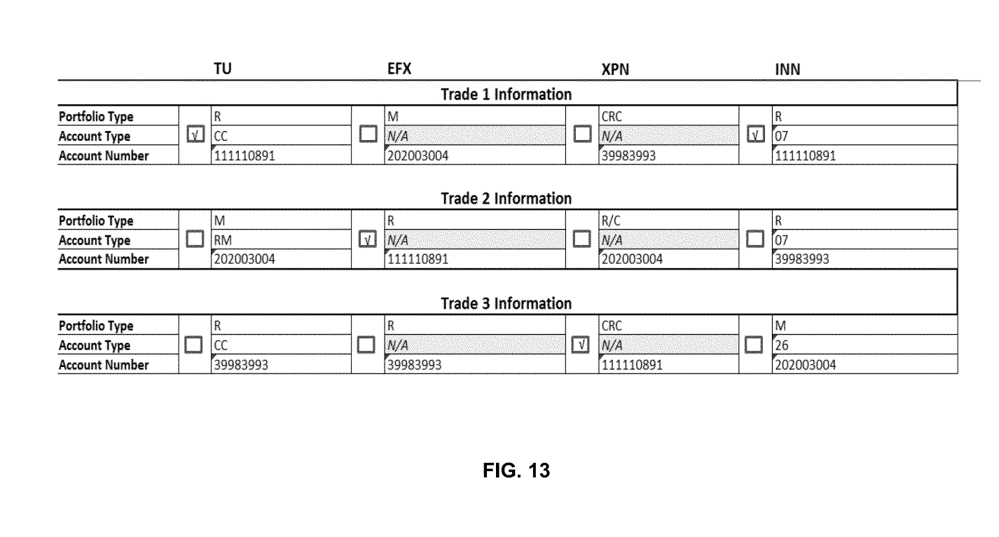

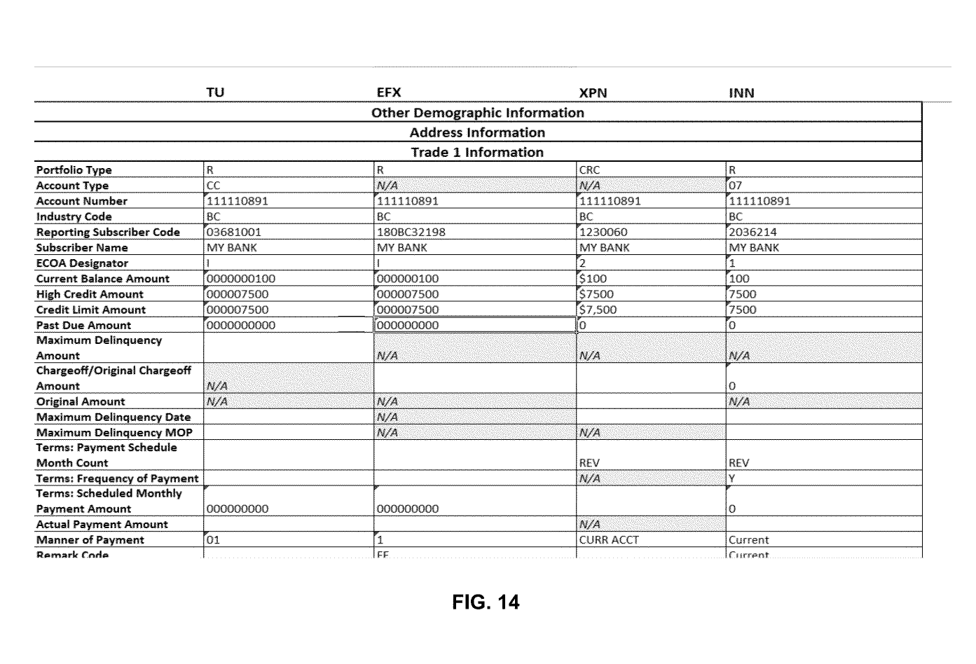

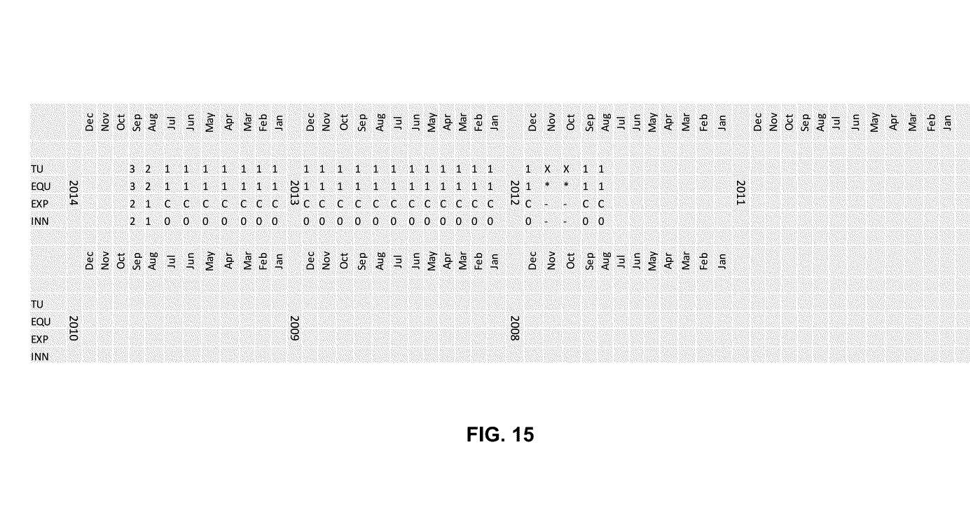

In an embodiment, after the credit data for an individual has been retrieved in response to a credit data review request, the credit data retrieval and processing engine 102 may enable a user to select specific trade lines from the raw credit data to view in more detail, as shown in the exemplary screenshots of FIGS. 12-15. In FIG. 12, multiple trade lines are displayed by the credit data retrieval and processing engine 102 to the user in the order retrieved from each credit bureau 170. Each of the displayed trade lines shows only certain elements (e.g., portfolio type, account type, account number) so that the user can quickly identify trade lines of interest. The user can select a trade line of interest from each credit bureau 170 by selecting the appropriate check boxes, as shown in FIG. 13. The example shown in FIG. 13 reflects the user selecting the trade line with the same account number for each of the credit bureaus 170. After selecting the trade lines of interest, the credit data retrieval and processing engine 102 may display full details of the selected trade lines and place the data fields for each of the credit bureaus 170 next to one another, as shown in FIG. 14. The historical payment pattern for the selected trade lines for each of the credit bureaus 170 may also be displayed by the credit data retrieval and processing engine 102, in some embodiments, as shown in FIG. 15.

Any process descriptions or blocks in figures should be understood as representing modules, segments, or portions of code which include one or more executable instructions for implementing specific logical functions or steps in the process, and alternate implementations are included within the scope of the embodiments of the invention in which functions may be executed out of order from that shown or discussed, including substantially concurrently or in reverse order, depending on the functionality involved, as would be understood by those having ordinary skill in the art.

It should be emphasized that the above-described embodiments of the invention, particularly, any “preferred” embodiments, are possible examples of implementations, merely set forth for a clear understanding of the principles of the invention. Many variations and modifications may be made to the above-described embodiment(s) of the invention without substantially departing from the spirit and principles of the invention. All such modifications are intended to be included herein within the scope of this disclosure and the invention and protected by the following claims.

1. A system for processing credit data for centralized review, comprising:
a credit data database for storing credit data retrieved from a plurality of credit bureaus; and
a credit data retrieval and processing engine in communication with the credit data database, a user terminal comprising a display and an input device, and the plurality of credit bureaus, the credit data retrieval and processing engine for:
receiving a credit data review request associated with an individual from the input device of the user terminal;
retrieving the credit data from the plurality of credit bureaus, based on the credit data review request;
transmitting a plurality of access links to the display of the user terminal, the plurality of access links for viewing the retrieved credit data;
storing the retrieved credit data in the credit data database;
identifying a plurality of data fields in the retrieved credit data;
formatting the plurality of data fields for comparison; and
transmitting the plurality of formatted data fields to the display of the user terminal.
